(19) United States
(12) Patent Application Publication
(10) Pub. No.: US 2004/0260775 A1
(43) Pub. Date: Dec. 23, 2004

(54) System and method for sending messages

(75) Inventor: Samuel A. Fedele, Victor, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/601,251

(22) Filed: Jun. 20, 2003

(51) Int. Cl. G06F 15/16

(52) U.S. Cl. 709/206; 709/203

(57) ABSTRACT

A system and method for sending a message containing a data object, comprising forming a second data object based upon the first data object, the second message being stored in a storage device, forming a second message based upon a first message the second message containing a reference to the storage location of the second data object and sending the second message to a recipient. The determination to store and defer sending message content may be based upon a comparison of the size of the first data object size to a pre-determined threshold. The threshold may be set at a local or enterprise level. Further analysis of the second data object may be performed to determine if the data object is to be distributed to the recipient.

### INCORPORATION BY REFERENCE OF OTHER U.S. PATENTS

The application hereby incorporates by reference the disclosures of Zhigang Fan, “Anti-counterfeit pattern detector and method,” U.S. Pat. No. 5,553,144; Zhigang Fan, et. al., “Seal detection system and method,” U.S. Pat. No. 6,067,374; Zhigang Fan, et. al., “Method for counterfeit currency detection using orthogonal line comparison,” U.S. Pat. No. 6,181,813 B1, John W. Wu, et. al., “Anti-counterfeit detection method,” U.S. Pat. No. 6,317,524, and, John W. Wu, et. al., “Digital imaging method and apparatus for detection of document security marks,” U.S. Pat. No. 6,542,629, verbatim and with the same effect as though such disclosures were fully and completely set forth herein.

### BACKGROUND OF THE INVENTION

It is often desirable to send an electronic message that includes one or more components. By way of example, it is common to send an electronic mail message that consists of a short text message, and to include as part of the electronic mail message a more complex document such as a Mircosoft Word™ or Microsoft Powerpoint™ presentation. Word™ and PowerPoint™ are trademarks registered to Microsoft Corporation, One Microsoft Way, Redmond Wash., 98052. This provides a convenient way of sending a complex formatted document from a sender to one or more recipients.

However, this common practice of sending large attachments can have the impact of burdening the communications infrastructure used to send or transmit the messages. This increased burden can raise the cost and degrade the performance of the communications infrastructure. Malicious individuals have also been known to send harmful data or programs to unsuspecting recipients; such harmful data or programs are often referred to as viruses. These viruses can cause damage to data, programs or other items resident in the communications infrastructure, or otherwise degrade the performance of the communications infrastructure. Further, there is increased concern within enterprises for the security of enterprise information. These security concerns may relate to controlling the distribution of enterprise confidential information, or protecting the privacy of clients of the enterprise, such as by restricting the circulation of client health or financial information. Additionally, there is increased concern within enterprises that the enterprise communications infrastructure is used only for the transmission of messages and attachments legitimately related to the mission of the enterprise. By way of example, an enterprise may want to restrict or prohibit the transmission of attachments such as vacation pictures, digital greeting cards, or games.

Therefore, there is a need for an improved system and method for sending messages with attachments in a communications infrastructure.

### SUMMARY OF THE INVENTION

In a first aspect of the invention there is a computer program arranged to process a first message, the first message comprising a first data object, the process based on a method comprising: forming a second data object based on the first data object, the second data object to be stored in a storage device at a storage address; forming a reference information based upon the storage address; and, forming a second message comprising the reference information and devoid of at least part of the first data object.

In a second aspect of the invention there is a sending device arranged to process a first message including a first data object based on a method comprising: forming a second data object based upon the first data object, the second data object to be stored in storage device at a storage address; forming a reference information based on the storage address and, forming a second message comprising the reference information and devoid of at least part of the first data object.

In a third aspect of the invention there is a method to distribute a first message containing a first data object to a recipient, comprising: by a device, determining when the first data object is greater than a specified threshold; by a device, forming a second data object wherein at least a portion of the content of the second data object is equivalent to the content of the first data object, and storing the second data object in a storage device at a storage address when the first data object is greater than the specified threshold; by a device, forming a second message without at least a portion of the first data object, and forming within the second message a reference information based on the storage address when the first data object is greater than the specified threshold; and, by a device, sending the second message to the recipient;

In a fourth aspect of the invention there is a system comprising a receiving device, a storing device and a sending device, wherein the sending device is arranged to process a first message including a first data object based on a method comprising: forming a second data object based upon the first data object, the second data object to be stored in a storage device at a storage address; forming a reference information based on the storage address and, forming a second message comprising the reference information and devoid of at least part of the first data object; and where the receiving device, a storing device and sending device are arranged to be coupled to a communications network.

### BRIEF DESCRIPTION OF THE DRAWINGS

FIG. 1 is a block diagram depicting a system 100 for sending a message in accordance with the current invention. System 100 is also suitable for a method of sending a message in accordance with the current invention. System 100 comprises a sending device 103, for sending a message 104, comprising first data object 105, to recipient 102. Sending device 103, forms a second data object 105′, the second data object 105′ stored in storage device 109 at a storage address. Sending device 103 forms a second message 104′ devoid of at least part of first data object 105 and comprising a reference information 110 based upon the storage address. Recipient 102 receives and reads second message 104′, and retrieves the data object 105′ from the electronic repository making use of the reference information 110.

FIG. 2 depicts a representative embodiment of the sending device (reference FIG. 1, 103) and program 106 in accordance with the current invention, wherein the sending device (reference FIG. 1, 103) comprises a message client 200. Program (reference FIG. 1, 106) comprises a message client program 210 in operative communication with a plug-in program 220.

FIG. 3 depicts an alternate embodiment of the sending device (reference FIG. 1, 103) and program (reference FIG. 1, 106) wherein, the sending device 300 comprises a message client 310 in operative communication with a message server 320 via network 311.

FIG. 4 depicts one embodiment of a method for sending a message in accordance with the invention.

FIG. 5 depicts one embodiment of a method by which the recipient (reference FIG. 1, 102) receives the second message; reads the second message and retrieves the data object (reference FIG. 1, 105′) from the electronic repository (reference FIG. 1, 109); in accordance with the invention.

FIG. 6 depicts an alternate embodiment of a method for sending a message in accordance with the current invention.

### DETAILED DESCRIPTION OF THE INVENTION

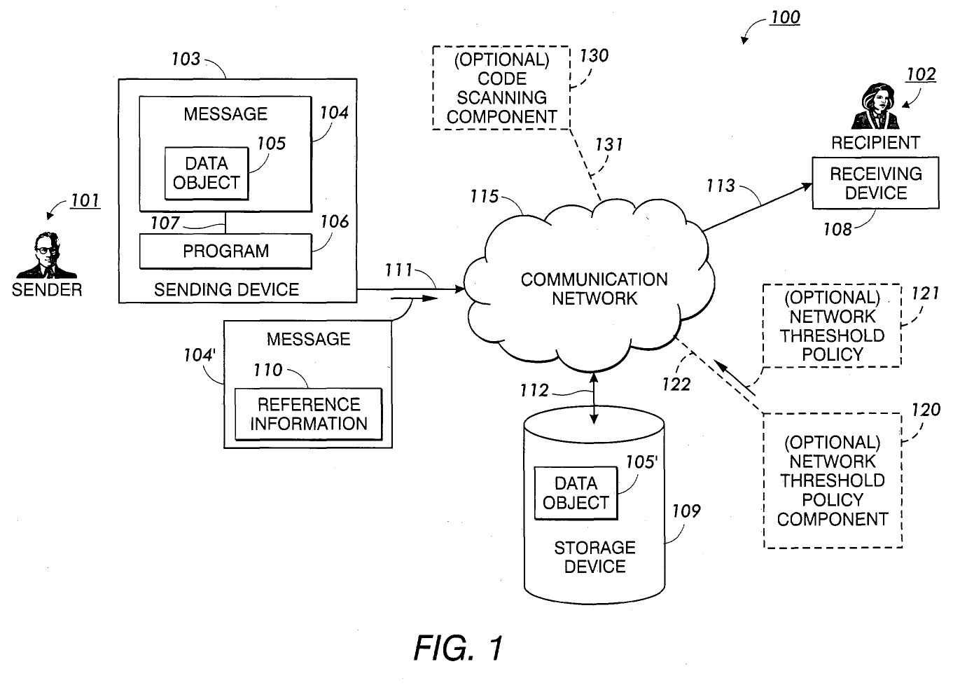

Referring to FIG. 1, there is shown a block diagram depicting a system 100 for sending a message. System 100 is also suitable for a method of sending a message in accordance with the current invention. System 100 comprises a sending device 103, responsive to sender 101 for sending a message to recipient 102. Message 104, comprising data object 105 is resident upon sending device 103 and accessible for data processing by computer program 106 via communications pathway 107. Sending device 103, forms a second data object 105′, based on the first data object 105, the second data object 105′ stored in storage device 109 at a storage address. Sending device 103, further forms a reference information 110 based upon the storage address; and, forms a second message 104′ comprising the reference information 110 and devoid of at least part of the first data object 105. In one representative embodiment of the invention, the threshold used by program 106 is communicated by optional network threshold policy component 120 as optional network threshold policy 121 via communications pathway 111-122. Recipient 102 receives and reads second message 104′, and retrieves the data object 105′ from the electronic repository making use of the reference information 110. Optionally, sending device 103 determines when data object 105 is smaller than a threshold, and in response thereto, sends the first message 104, comprising the first data object 105, to recipient 102. Optionally, code scanning component 130 may analyze stored data object 105′ to determine if data processing steps are to be applied to data object 105′. Examples of analysis performed by optional code scanning component 130 include determining if stored data object 105′ comprises a computer virus, an image file or confidential information.

Still referring to FIG. 101, in one embodiment, sending device 103 determines if the size of first message 104, exceeds a threshold. The sending device 103, forms the second data object 105′, reference information, and second message 104′ only when the size of the first data object exceeds the threshold. Several mechanisms may be used to establish the value of the threshold. In one embodiment the value of the threshold is transmitted to the sending device 103 by a network threshold policy component 120 in operative communication with the sending device 103 via communications pathway 111-122. In one embodiment the network threshold policy component 120 is a server. The network threshold policy component 120 transmits a data message, the network policy threshold 121, providing the sending device 103, with the value of the threshold to be used in the determination. Methods for communicating data messages via a communications network are well known to those skilled in the art.

Still referring to FIG. 1, sending device 103, responsive to sender 101, forms a second data object based on the first data object 105, the second data object to be stored in a storage device 109 at a storage address as a stored data object 105′. The second data object may comprise all or portions of the first data object 105. In one embodiment, the stored data object 105′ is a replica of first data object 105. In an alternate embodiment, stored data object 105′ is an encrypted version of the first data object 105′. In yet a further embodiment, the stored object 105′ is a partial replica of first data object 105.

Still referring to FIG. 1, in one embodiment storage device 109 is a file server. In an alternate embodiment, storage device 109 is a Docushare™ server, available from Xerox Corporation 800 Long Ridge Road Stamford Conn. 06904. server. Docushare™ is a trademark registered to Xerox Corporation, P.O. Box 1600 800 Long Ridge Road Stamford Conn. 06904. In an alternate embodiment storage device 109 is a Sharepoint™ server, available from Microsoft Corporation, One Microsoft Way Redmond, Wash. 980526399. Sharepoint is a trademark registered to Microsoft Corporation, One Microsoft Way Redmond, Wash. 980526399. In another embodiment, storage device 109 is a Lotus Notes™ server, available from Lotus Notes Development Corporation, 55 Cambridge Parkway, Cambridge Mass., 02142. Lotus Notes™ is a trademark registered to Lotus Notes Development Corporation, 55 Cambridge Parkway, Cambridge Mass., 02142.

Again referring to FIG. 1, the sending device 103 forms a reference information 110 based upon the storage address; and, forms a second message 104′ comprising the reference information 110 and devoid of at least part of the first data object 105. Numerous methods for specifying the storage address of a data object on a storage device are well known to those skilled in the art. In one embodiment the storage address is a Universal Resource Locator (URL).

Still referring to FIG. 1, optionally, sending device 103 establishes access rights for data object 105′ stored on storage device 109 restricting access to data object 105′. Multiple methods of establishing access rights are well known to those skilled in the arts. In one embodiment, sending device 103 establishes access rights allowing only recipient 102 to retrieve data object 105′ from storage device 109. In an alternate embodiment, sending device 103 establishes access rights that prevent recipient 102 from retrieving data object 105′. As described below with reference to optional code scanning component 130, access rights to data object 105′ permitting recipient 102 to retrieve data object 105′ are established only after optional code scanning component 130 determines that the data object 105′ may be retrieved by recipient 102.

Still referring to FIG. 1, in one embodiment, the communications network 115 comprises a local area network. In another embodiment the communications network 115 comprises a wide area network. In another embodiment the communications network 115 comprises a wireless network. In another embodiment the communications network 115 comprises an Internet. In another embodiment communications network 115 is a cellular telephone network.

Again referring to FIG. 1, in one embodiment optional code scanning component 130 analyzes data object 105′ stored on storage device 109 to determine if data object 105′ may be retrieved by recipient 102. In one embodiment, the code scanning component 130 comprises a server in operative communication with storage device 109. In another embodiment optional code scanning component 130 analyzes data object 105′ to determine if data object 105′ contains a virus. By way example and not limitation, the virus may be a computer virus, a cellular phone virus, a text messaging device virus or a personal digital assistant (PDA) virus. Numerous methods are known to those skilled in the art for detecting and responding to viruses. In one embodiment optional code scanning component 130 deletes a virus found upon analysis of data object 105′. One example of a computer program to detect and respond to viruses is provided by Symantec Enterprise Security Manager, available from Symantic Enterprises, 20330 Stevens Creek Blvd., Cupertino, Calif. 95014-2132

Still referring to FIG. 1, in one embodiment, code scanning component 130 may analyze data object 105′ to determine if data object 105′ comprises a file type that may be distributed on the network based upon the enterprise policies. By way of example, and not limitation, many information systems store data objects as files with a file name comprised of a leading alpha-numeric string, a period, “.”, and a trailing extension, that is commonly three (3) characters long. The determination of whether to further distribution distribute files is based upon analysis of the file extension. In one embodiment, image files are not allowed to be distributed. In another embodiment image files further comprising an image of currency, or an image of security marks used in the printing of currency are not permitted to be distributed. By way of example and not limitation, methods for determining whether an image further comprises currency image, or an image of security marks used in the printing of currency, are disclosed in Zhigang Fan, “Anti-counterfeit pattern detector and method,” U.S. Pat. No. 5,553,144; Zhigang Fan, et. al., “Seal detection system and method,” U.S. Pat. No. 6,067,374; Zhigang Fan, et. al., “Method for counterfeit currency detection using orthogonal line comparison,” U.S. Pat. No. 6,181,813 B1; John W. Wu, et. al., “Anti-counterfeit detection method,” U.S. Pat. No. 6,317,524; and, John W. Wu, et. al., “Digital imaging method and apparatus for detection of document security marks,” U.S. Pat. No. 6,542,629, herein incorporated verbatim and with the same effect as though such disclosures were fully and completely set forth herein.

Still referring to FIG. 1, in one embodiment, code scanning component 130 may analyze data object 105′ to determine if a data object 105′ comprises confidential information. In one embodiment code scanning component 130 analyzes data object 105′ to identify text that is known to corresponding to confidential information. Methods to analyze digital data to identify predetermined key words are well known to those skilled in the art.

Again referring to FIG. 1, in one embodiment, the actions of sending device 103 performed in accordance with the invention, as described herein, are performed by program 106. By a program it is meant implementations that include software, firmware and hardware, including but not limited to ASICS and PGA's. Multiple methods for implementation of a program are well known to those skilled in the art.

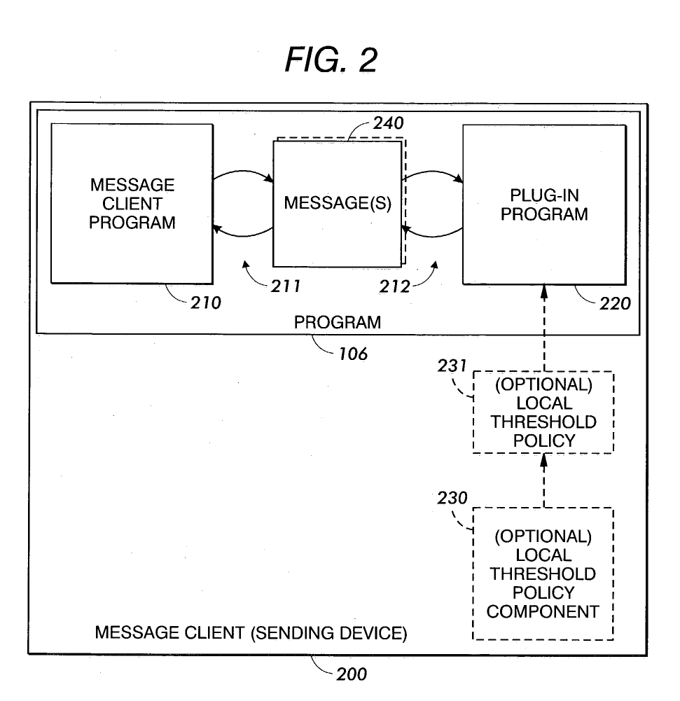

Referring now to FIG. 2, there is shown a schematic diagram depicting a representative embodiment of the sending device (reference FIG. 1, 103) and program 106 in accordance with the current invention, wherein the sending device (reference FIG. 1, 103) comprises a message client 200. By way of example and not limitation, a message client may comprise a personal computer, a cell phone, a text message device, or a personal digital assistant (PDA). In one embodiment, sending device 200 comprises an electronic mail client device such as a personal computer. In a further embodiment, program 106 comprises an electronic mail client program, and the first message (reference FIG. 1, 104) comprises an electronic mail message with an attachment, the attachment corresponding to first data object 105. An example of an electronic mail client program is Microsoft Outlook™, available from Microsoft Corporation, One Microsoft Way Redmond, Wash. 980526399. Outlook™ is a trademark registered to Microsoft Corporation, One Microsoft Way Redmond, Wash. 980526399.

Referring still to FIG. 2, program 106 comprises a message client program 210 in operative communication with a plug-in program 220. Message client program 210 and plug-in program 212 are in operative communication via exchange of messages 240, via their application programming interfaces 211 and 212. Numerous methods for communication of messages between two computer program are well known to one skilled in the art. In one further embodiment, the plug-in component 212 determines whether first data object 105 is greater than the aforementioned pre-determined threshold. In one embodiment, computer program (reference FIG. 1, 106) further comprises the threshold. In an alternate embodiment, the threshold may be communicated by optional local threshold component 230 in operative communication with plug-in component 212. In one embodiment the optional local threshold policy 230 component is a computer program and optional local threshold hold policy 231 is a message. In an alternate embodiment optional local threshold policy component 230 is a data object locally accessible to plug-in component 212, further comprising local threshold policy 231.

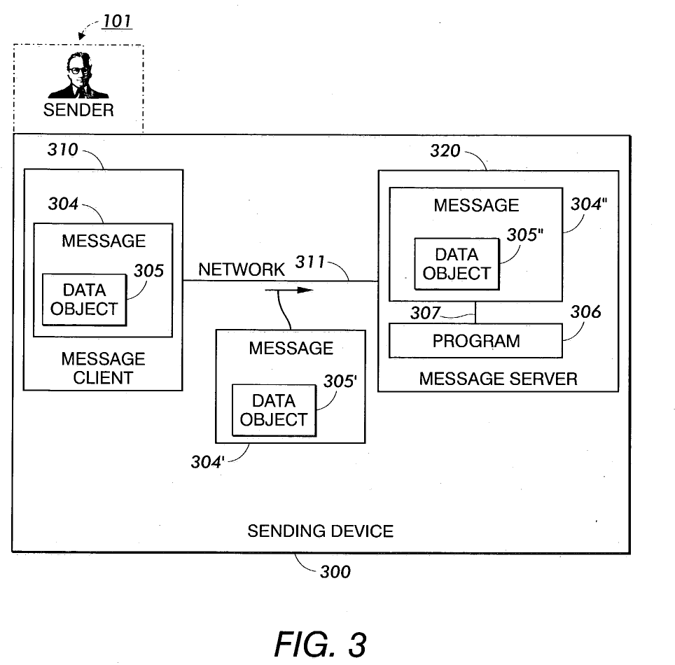

Referring now to FIG. 3, in accordance with the invention, there is depicted a block diagram disclosing an alternate embodiment of the sending device 300 corresponding to sending device 103 in FIG. 1. Sending device 300 comprises a message client 310, for sending a message 304. Message 304, further comprising data object 305, is resident upon message client 310. Responsive to sender 101, message client 310 sends message 304 as message 304′, further comprising data object 305′ via communications pathway 311 to message server 320, where it is received as message 304″ and data object 305″.

In one embodiment, message client 310 comprises an electronic mail message client. In a further embodiment, message server 320 comprises an electronic mail server. By way of example and not limitation, in one embodiment message client 310 is a POP3 electronic mail client operating on a personal computer and message server 320 is a POP3 electronic mail server. In a second embodiment, message client 310 comprises a text message device. In a third embodiment, message client 310 comprises a cellular telephone. In a fourth embodiment, message 310 comprises a personal digital assistant (PDA). One skilled in the art will recognize these are but exemplary embodiments of the invention and recognize alternate embodiments thereof.

Still referring to FIG. 3, in one embodiment network 311 comprises a local area network (LAN). In another embodiment network 311 comprises a wide area network (WAN). In an alternate embodiment, network 311 comprises a cellular telephone network. In yet another embodiment, network 311 comprises a wireless network. One skilled in the art will recognize these are but exemplary embodiments of the invention and recognize alternate embodiments thereof.

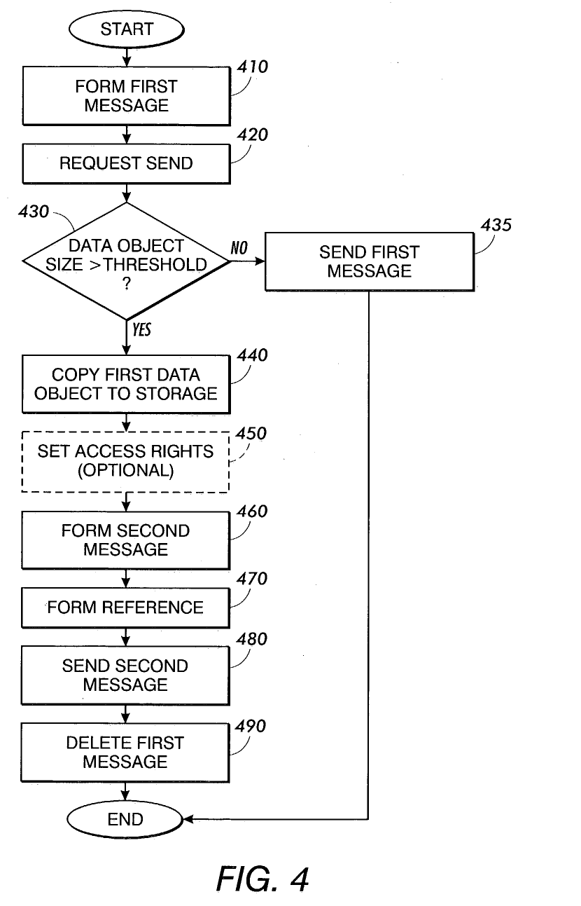

Referring now to FIG. 4, there is shown in accordance with the invention, a process flow chart describing one embodiment of a method to distribute a first message containing a first data object to a recipient, comprising: by a device, determining when the first data object is greater than a specified threshold; by a device, forming a second data object wherein at least a portion of the content of the second data object is equivalent to the content of the first data object, and storing the second data object in a storage device at a storage address when the first data object is greater than the specified threshold; by a device, forming a second message without at least a portion of the first data object, and forming within the second message a reference information based on the storage address when the first data object is greater than the specified threshold; and, by a device, sending the second message to the recipient.

Still referring to FIG. 4, the process flow begins with step 410, forming a first message. As previously disclosed with reference to FIG. 1-3, first message (reference FIG. 1, 104) further comprises a first data object (reference FIG. 1, 105). Step 420 comprises requesting the first message (reference FIG. 1, 104) to be sent. Means for forming the first message (reference FIG. 1, 104) and means for requesting sending of the first message (reference FIG. 1, 104) may be any means known to those skilled in the art. Step 430 comprises determining if the size of the first data object (reference FIG. 1, 105) is greater than a threshold value. If the size of the first data object (reference FIG. 1, 105) is less than the threshold value, the flow chart moves from step 430 to 435, wherein the first message (reference FIG. 1, 104), comprising the first data object (reference FIG. 1, 105), is sent. After process step 435, the process flow ends.

Still referring to FIG. 4, if the size of the first data object (reference FIG. 1, 105) is greater than the threshold, the flow chart moves to step 440, wherein a second data object (reference FIG. 1, 105′) based upon the first data object is formed and copied to the storage device (reference FIG. 1, 109) at a storage address. Optionally, during process step 450 sending device (reference FIG. 1, 103) establishes access rights for the data object (reference FIG. 1, 105′) stored on the storage device (reference FIG. 1, 109). As previously disclosed with reference to FIG. 1, in one embodiment, access rights are established such that there is a reasonable assurance that only the recipient may retrieve the data object 105′. In an alternate embodiment access rights are established such that there is a reasonable assurance that the recipient may not retrieve the data object 105′ until after an analysis step has been performed as was described with reference to FIG. 1.

Still referring to FIG. 4, during process step 460 a second message is formed. In one embodiment the sending device (reference 1, FIG. 103) forms the second message by first creating a replica of the first message devoid of at least a portion of the first data object (reference FIG. 1, 105). In a further embodiment, the second message is initially formed devoid of a reference information (reference FIG. 1, 110). During process step 470 the reference information is formed as a part of the second message to complete formation of the second message (reference FIG. 1, 104′). In process step 480, the second message is sent to the recipient (reference FIG. 1, 102). Moving to option process step 490, data object (reference FIG. 1, 105′) is deleted. After process step 490 the process flow is completed.

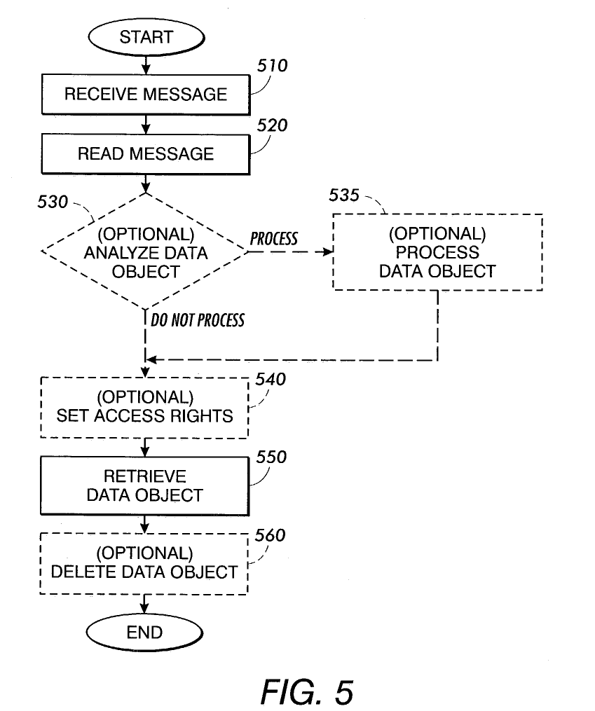

Referring now to FIG. 5, there is shown in accordance with the invention, a process flow chart describing one embodiment of a method comprising: the recipient reading the second electronic mail message; retrieving the data object (reference FIG. 1, 105′) from the electronic repository (reference FIG. 1, 109); and, deleting the data object (reference FIG. 1, 105′) from the electronic repository (reference FIG. 1, 105′). In accordance with the invention, the process flow chart further describes one embodiment of a method to determine if the second data object (reference FIG. 1, 105′) comprises at least some digital information that requires application of data processing steps and in response thereto, apply said processing steps.

Still referring to FIG. 5, in process step 510 recipient (reference FIG. 1, 102) receives the message. Means for receiving the message may be any means known to those skilled in the art. In process step 520, recipient (reference FIG. 1, 102) reads the message. Optionally, as has been described with reference to FIG. 1, in process step 530, optional network scanning component (reference FIG. 1, 130), analyzes the data object (reference FIG. 1, 105′) stored on storage device (reference FIG. 1, 109), to determine if the data object (reference FIG. 1, 105′) comprises at least some digital information that requires application of data processing steps. By way of example, and not limitation, the digital information requiring data processing may comprise, a virus, an image file, an image of currency, or confidential information.

Still referring to FIG. 5, if optional scanning component (reference FIG. 1, 130) determines the data object (reference FIG. 1, 105′) stored on storage device (reference FIG. 1, 109), comprises at least some digital information that requires application of data processing steps, the process flow moves to process step 535. As part of process steps 535, optional scanning component (reference FIG. 1, 130) performs required data processing, after which the process flow moves to optional process step 540. If optional scanning component (reference FIG. 1, 130) determines the data object (reference FIG. 1, 105′) stored on storage device (reference FIG. 1, 109), does not comprise at least some digital information that requires application of data processing steps, the process flow moves to optional process step 540. As part of optional process step 540, optional scanning component (reference FIG. 1, 130) establishes access rights to the data object 105′ stored on the storage device such that there is a reasonable assurance that only the recipient may retrieve the data object 105′.

Still referring to FIG. 5, in process step 540, recipient (reference FIG. 1, 102) retrieves stored data object (reference FIG. 1, 105′) stored on storage device (reference FIG. 1, 109) using reference information (reference FIG. 1, 110) in the message (reference FIG. 1, 104). Means for retrieving the data object (reference FIG. 1, 105′) using the reference information (reference FIG. 1, 110) may be any means known to those skilled in the art. After retrieving the data object (reference FIG. 1, 105′), in optional process step 560, the data object (reference FIG. 1, 105′) is deleted, after which the process flow ends.

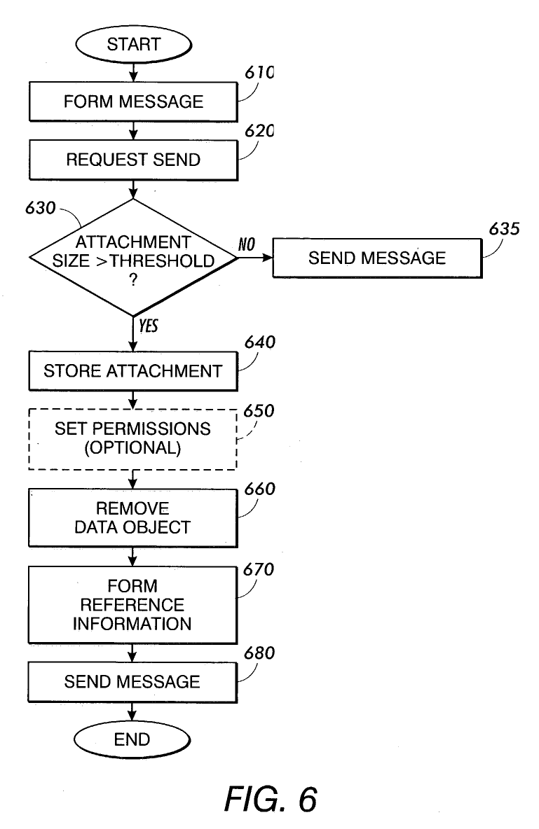

Referring now to FIG. 6, there is shown in accordance with the invention, a process flow chart describing an alternate embodiment of a method to distribute a first message containing a first data object to a recipient, comprising: by a device, determining when the first data object is greater than a specified threshold; by a device, forming a second data object wherein at least a portion of the content of the second data object is equivalent to the content of the first data object, and storing the second data object in a storage device at a storage address when the first data object is greater than the specified threshold; by a device, forming a second message without at least a portion of the first data object, and forming within the second message a reference information based on the storage address when the first data object is greater than the specified threshold; and, by a device, sending the second message to the recipient.

Still referring to FIG. 6, the process flow begins with step 610, forming a first message. As previously disclosed with reference to FIG. 1-3, first message (reference FIG. 1, 104) further comprises a first data object (reference FIG. 1, 105). Step 620 comprises requesting the first message (reference FIG. 1, 104) to be sent. Means for forming the first message (reference FIG. 1, 104) and means for requesting sending of the first message may be any means known to those skilled in the art. Step 630 comprises determining if the size of the first data object (reference FIG. 1, 105) is greater than a threshold value. If the size of the first data object (reference FIG. 1, 105) is less than the threshold value, the flow chart moves from step 630 to 635, wherein the first message (reference FIG. 1, 104), comprising the first data object (reference FIG. 1, 105), is sent. After process step 635, the process flow ends.

Still referring to FIG., 6, if the size of the first data object is greater than the threshold, the flow chart moves to step 640, wherein a second data object (reference FIG. 1, 105′) based upon the first data object is formed and stored on the storage device (reference FIG. 1, 109) at a storage address. FIG. 1, 109). Optionally, during process step 650 sending device (reference FIG. 1, 103) establishes access rights for the data object (reference FIG. 1, 105′) stored on the storage device (reference FIG. 1, 109). During optional process step 650, access rights to the stored data object (reference FIG. 1, 105′) are established. As previously disclosed with reference to FIG. 1, in one embodiment, access rights are established such that there is a reasonable assurance that only the recipient may retrieve the data object (reference FIG. 1, 105′). In an alternate embodiment access rights are established such that there is a reasonable assurance that the recipient may not retrieve the data object (reference FIG. 1, 105′) until after an analysis step has been performed as was described with reference to FIG. 1.

Still referring to FIG. 6, during process step 660 a second message is formed. In one embodiment the sending device (reference 1, FIG. 103) forms the second message by removing at least a portion of the first data object (reference FIG. 1, 105) from the first message (reference 1, FIG. 103). During process step 670 a reference information based upon the storage address is formed as a part of the second message to complete formation of the second message (reference FIG. 1, 104′). During process step 690, the second message is sent to the recipient (reference FIG. 1, 102). After process step 690 the process flow is completed.

What is claimed is:

1. A computer program arranged to process a first message, the first message comprising a first data object, the process based on a method comprising:
(a) forming a second data object based on the first data object, the second data object to be stored in a storage device at a storage address;
(b) forming a reference information based upon the storage address; and,
(c) forming a second message comprising the reference information and devoid of at least part of the first data object.

2. The computer program of claim 1, wherein at least a portion of the computer program resides on a message client.

3. The computer program of claim 2, wherein the computer program further comprises a plug-in program in operable communication with a message client program.

4. The computer program of claim 2, where the computer program is an e-mail client computer program.

5 The computer program of claim 1, wherein at least a portion of the computer program resides on a message server.

6. The computer program of claim 5, wherein the message server is an e-mail server.

7. The computer program of claim 1, the method further comprising sending the second message to a recipient.

8. The computer program of claim 7, wherein sending the second message occurs via a communications network.

9. The computer program of claim 8, wherein the communications network comprises a wireless network.

10. The computer program of claim 8, wherein the communications network comprises an internet.

11. The computer program of claim 1, the method further comprising setting access controls restricting access to the second data object.

12. The computer program of claim 11, the first message comprising an e-mail message.

13. The computer program of claim 12, the second message comprising an e-mail message.

14. The computer program of claim 1, the method further comprising determining when the size of the first data object exceeds a threshold.

15. The computer program of claim 14, wherein the threshold is one thousand bytes.

16. The computer program of claim 14, wherein forming a second data object, forming a reference information, and forming a second message are performed only when the size of the first data object exceeds the threshold.

17. The computer program of claim 14, wherein the threshold is determined by a threshold policy component.

18. The computer program of claim 17, wherein the threshold policy component is a local threshold policy component.

19. The computer program of claim 17, wherein the threshold policy component is a network policy component.

20. The computer program of claim 14, wherein the threshold is a fixed value that is part of the program code.

21. The computer program of claim 1, where the storage device is a file server.

22. The computer program of claim 21, wherein, the reference is a universal resource locator (URL).

23. The computer program of claim 21, wherein, the storage device is a Docushare server.

24. The computer program of claim 21, wherein the storage device is a Sharepoint server.

25. The computer program of claim 21, wherein the storage device is a Lotus Notes server.

26. A sending device 3 arranged to process a first message 4 including a first data object 5 based on a method comprising:
(a) forming a second data object based upon the first data object, the second data object to be stored in storage device at a storage address;
(b) forming a reference information based on the storage address and,
(c) forming a second message comprising the reference information and devoid of at least part of the first data object.

27. The sending device of claim 26, wherein the sending device comprises a message client.

28. The sending device of claim 27, where the sending device further comprises an e-mail message client.

29. The sending device of claim 27, where the sending device further comprises a cell phone.

30. The sending device of claim 27, where the sending device further comprises a text messaging device.

29. The sending device of claim 27, where the sending device comprises a personal digital assistant.

32. The sending device of claim 28, wherein the sending device further comprises a message server.

33. The sending device of claim 26, wherein the sending device comprises a message server.

34. The sending device of claim 26, the method further comprising sending the second message to a recipient.

35. The sending device of claim 31, wherein sending the second message occurs via a communications network.

36. The sending device of claim 35, wherein the communications network comprises a wireless network.

37. The sending device of claim 36, wherein the communications network. comprises an Internet.

38. The sending device of claim 26, the method further comprising setting access controls restricting access to the second data object.

39. The sending device of claim 26, the first message comprising an e-mail message.

40. The sending device of claim 39, the second message comprising an e-mail message.

41. The sending device of claim 26, the method further comprising determining when the size of the first data object exceeds a threshold.

42. The sending device of claim 41, wherein the threshold is one thousand bytes.

43. The sending device of claim 41, wherein forming a second data object, forming a reference information, and forming a second message are performed only when the size of the first data object exceeds the threshold.

44. The sending device of claim 38, wherein the threshold is determined by a threshold policy component.

45. The computer program of claim 44, wherein the threshold policy component is a local threshold policy component.

46. The computer program of claim 45, wherein the threshold policy component is a network policy component.

47. The computer program of claim 44, wherein the threshold is a fixed value that is part of the program code.

48. The sending device of claim 26, where the storage device is a file server.

49. The sending device of claim 48, wherein, the reference information is a universal resource locator (URL).

50. The sending device of claim 48, wherein, the storage device is a Docushare server.

51. The sending device of claim 48, wherein the storage device comprises a message client.

52. A method to distribute a first message containing a first data object to a recipient, comprising:
a) by a device, determining when the first data object is greater than a specified threshold;
b) by a device, forming a second data object wherein at least a portion of the content of the second data object is equivalent to the content of the first data object, and storing the second data object in a storage device at a storage address when the first data object is greater than the specified. threshold;
c) by a device, forming a second message without at least a portion of the first data object, and forming within the second message a reference information based on the storage address when the first data object is greater than the specified threshold; and,
d) by a device, sending the second message to the recipient;

53. The method of claim 52, by a device, further comprising establishing access rights to the second data object stored on the storage device such that there is a reasonable assurance that only the recipient may retrieve the second data object.

54. The method of claim 53 further comprising the recipient reading the second message.

55. The method of claim 53 further comprising retrieving the second data object.

56. The method of claim 52, wherein forming the second message without at least a portion of the first data object comprises creating a replica of the first message devoid of at least a portion of the first data object.

57. The method of claim 56, wherein creating the second message comprises creating the second message with the reference information therein.

58. The method of claim 56, further comprising adding the reference information to the second message.

59. The method of claim 56, wherein forming the second message comprises removing at least a portion of the first data object from the first message.

60. The method of claim 58, wherein forming the second message is performed by a sending device.

61. The method of claim 52, further comprising:
a) the recipient reading the second electronic mail message;
b) retrieving the second data object from the electronic repository; and,
c) deleting the second data object from the electronic repository.

62. The method of claim 52, further comprising analyzing the second data object to determine if the second data object comprises at least some digital information that requires application of data processing steps and in response thereto, apply said processing steps.

63. The method of claim 62, wherein the digital information is a virus.

64. The method of claim 63, further comprising deleting the virus from the second data object.

65. The method of claim 62, wherein the digital information is an image file.

66. The method of claim 65, wherein the image file further comprises an image of currency.

67. The method of claim 65, wherein the image file further comprises an image of security marks used in printing currency.

68. The method of claim 62, wherein the digital information is confidential information.

69. The method of claim 62, further comprising by a device, further comprising establishing access rights to the second data object stored on the storage device such that there is a reasonable assurance that only the recipient may retrieve the second data object.

70. A system comprising a receiving device, a storing device and a sending device, wherein the sending device is arranged to process a first message including a first data object based on a method comprising:
(a) forming a second data object based upon the first data object, the second data object to be stored in a storage device at a storage address;
(b) forming a reference information based on the storage address and,
(c) forming a second message comprising the reference information and devoid of at least part of the first data object; and where the receiving device, a storing device and sending device are arranged to be coupled application of data processing steps and in response thereto, apply said processing steps.

71. The system of claim 70 further comprising a network threshold policy component arranged to communicate a network threshold policy to the sending device.
